(19) United States
(12) Patent Application Publication
(10) Pub. No.: US 2026/0001389 A1
(43) Pub. Date: Jan. 1, 2026

(54) VEHICLE ROOF WITH SURFACE ELEMENT, METHOD FOR PRODUCING A SURFACE COMPONENT, AND DEVICE FOR PRODUCING A SURFACE COMPONENT

(71) Applicant: Webasto SE, Stockdorf (DE)

(72) Inventors: Martin Seebass, Stockdorf (DE); Thomas Schröferl, Stockdorf (DE)

(21) Appl. No.: 19/196,251

(22) Filed: May 1, 2025

(30) Foreign Application Priority Data
Jun. 28, 2024 (DE) 10 2024 118 439.6

(51) Int. Cl. B60J 7/057; B29C 44/12; B29C 44/58; B29L 31/30; B60J 10/90; F16C 1/06

(52) U.S. Cl. CPC B60J 7/057; B29C 44/1271; B29C 44/583; B60J 10/90; F16C 1/06; B29L 2031/30

(57) ABSTRACT

A vehicle includes a surface component which has a panel-like surface element which has an outer side facing the vehicle surroundings and an inner side facing the interior of the vehicle and on which a peripheral edge foaming is formed which is applied against a peripheral edge surface and against the inner side of the surface element in its edge region. At the edge foaming, a cable duct is shaped which is designed as open on its side along its extent. Alternatively, foamed into the edge foaming is a tube which forms a cable duct and which extends on the inner side of the surface element at least largely parallel to an edge surface portion of the surface element.

### CROSS-REFERENCE TO RELATED APPLICATION(S)

This application claims the benefit of German Application No. 102024118439.6, filed Jun. 28, 2025, which is incorporated herein by reference in its entirety.

### TECHNICAL FIELD

The invention relates to a vehicle roof, to a method for producing a surface component of a vehicle roof, and to a device for producing a surface component of a vehicle roof.

### BACKGROUND

A vehicle roof of the type mentioned at the beginning is known, for example, from the document DE 100 17 169 B4 and comprises a roof opening system which has a cover element, constituting a surface component, which can be adjusted between a closed position closing a roof opening and an uncovered position which at least partially uncovers the roof opening. This cover element comprises a panel-like surface element manufactured from glass or plastic which has an outer side or top side facing the vehicle surroundings and an inner side or underside facing the interior of the vehicle. The periphery of the surface element is provided with a so-called edge foaming which receives a reinforcing frame and, in the closed position of the cover element, has a sealing function with respect to adjoining vehicle roof regions. The edge foaming is applied peripherally against an edge surface and against the inner side of the surface element.

It is furthermore known from the prior art to equip surface components of a vehicle roof with ambient light functionality, i.e. with a lighting device which necessitates electrical components on the surface component. In order to be able to supply the electrical components with current, cables or leads are required.

### SUMMARY

The object of the invention is to provide a vehicle roof which comprises a surface component into which a cable guide is integrated in a visually appealing fashion. The object of the invention is furthermore to provide a method and a device for producing such a surface component.

According to the invention, a vehicle roof is therefore proposed which comprises a surface component which has a panel-like surface element which has an outer side facing the vehicle surroundings and an inner side facing the interior of the vehicle and on which a peripheral edge foaming is formed which is applied against a peripheral edge surface and against the inner side of the surface element in an edge region. At the edge foaming, a cable duct is shaped which is designed as open on its side along its extent and in particular has no separate trim elements which are connected to the edge foaming. Alternatively, foamed into the edge foaming is a tube which forms a cable duct and which extends on the inner side of the surface element largely parallel to an edge surface portion element.

In the vehicle roof according to the invention, a cable duct, i.e. a receptacle for an electrical lead, is thus integrated directly into the edge foaming, and to be precise without any additional elements by corresponding shaping of the edge foaming or alternatively by a tube which constitutes an inlaid part of the edge foaming and forms the cable duct.

The surface component of the vehicle roof according to the invention can be a stationary glass or plastic element which is fixed rigidly or immovably with respect to a vehicle body, or alternatively an unadjustable roof element of a roof opening system. The surface element can also be an in particular convex glass or plastic panel. It consists, for example, of laminated glass or single-pane safety glass.

In a preferred embodiment of the vehicle roof according to the invention, the edge foaming accommodates a reinforcement profile which substantially follows an edge surface portion of the panel-like surface element, wherein the cable duct is shaped at the edge foaming on that side of the reinforcement profile which is remote from this edge surface portion.

In order to be able to run an electrical lead, such as a cable, invisibly in the cable duct, in a preferred embodiment of the vehicle roof according to the invention the edge foaming has a trim lip which delimits the cable duct and the edge of which is spaced apart from the inner side of the surface element via an edge gap. The edge gap constitutes the side opening of the cable duct along its extent. The trim lip can be provided with a visually appealing outer side which can constitute a visible surface of the edge foaming. A high degree of customer acceptance can be achieved by such a cable duct, wherein at the same time the lead guided in the cable duct can be replaced easily.

In order to allow simple manufacture of the surface component according to the invention, in a preferred embodiment the cable duct is delimited above by the inner side of the surface element and moreover by the edge foaming. The cable duct is then preferably delimited at its underside by the trim lip.

Depending on customer requirements, the cable duct formed at the edge foaming can be formed peripherally or also comprise at least one substantially straight duct segment which follows an edge surface portion, extending in the longitudinal direction of the roof or the transverse direction of the roof, of the panel-like surface element and which is open at its ends.

In an alternative embodiment of the vehicle roof according to the invention, the cable duct is designed as open at the side remote from the outer side of the surface element, i.e. at the side facing the interior of the vehicle. In order in this case to arrange the cable duct and thus the electrical lead guided in the cable duct outside the field of vision of occupants of the vehicle, the cable duct is preferably formed on that side of a reinforcement profile in the edge foaming which faces an edge surface portion, extending in the longitudinal direction of the roof or the transverse direction of the roof, of the surface element. It is thus possible that the cable duct is covered by another element of the vehicle roof. In the case of a vehicle roof which comprises a roof opening system, the adjustable cover element of which constitutes the surface element which can be adjusted between a closed position closing a roof opening and an uncovered position at least partially uncovering the roof opening, a roof frame is preferably provided with a central or rear frame cross member. In its closed position, the cover element overlaps this frame cross member with a rear edge region at least partially in such a way that the cable duct is concealed by the roof cross member. The cable duct thus lies outside the field of vision of occupants of the vehicle. A lead guided in the cable duct can thus not be seen from the interior of the vehicle.

In order to be able to retain the electrical lead guided in the cable duct captively in the cable duct, the latter has preferably at least one undercut. The undercut can be implemented over the whole extent of the cable duct or also in some places in the manner of hooks. The edge gap which is caused by the cable duct being designed as open on its side then has a width which is less than the maximum opening width of the cable duct at right angles to the plane of the surface component or between the surface component and the edge foaming or its trim lip.

In a further specific embodiment of the vehicle roof according to the invention, the edge foaming has, along an edge surface portion, extending in the longitudinal direction of the roof or the transverse direction of the roof, of the surface element, a strip-like projection in which the cable duct is formed. The trim lip, which delimits the cable duct, can, for example, be shaped on the strip-like projection. Alternatively, the tube forming the cable duct can be accommodated in the strip-like projection.

The subject of the invention is also a method for producing a surface component of a vehicle roof, comprising the following steps:
Providing a panel-like surface element which has an inner side and an outer side;
Laying the surface element inside a molding tool which comprises a frame-like cavity for forming a edge foaming of the surface element;
Positioning a duct shaper in the cavity which has a bead-like edge region, wherein the duct shaper is placed against the inner side of the surface element;
Introducing a foam material into the cavity such that a edge foaming is shaped on the surface element; and
Demolding the surface element with the edge foaming and extracting the duct shaper from the edge foaming via an edge gap extending along the extent of the edge foaming.

By means of the method according to the invention, a surface component can be produced simply which has a panel-like surface element and a frame-like edge foaming which is provided with a cavity which is covered by the edge foaming itself, is shaped by the duct shaper, constitutes the cable duct, and has a lateral opening by virtue of the edge gap.

In an embodiment of the method according to the invention which is simple to implement, the duct shaper is formed from an elastic plastic profile, in particular from a silicone profile. The plastic profile can be designed as straight or curved. It is additionally conceivable that the plastic profile is formed peripherally or in the manner of a frame such that, by virtue of its use, a peripheral frame-like cable duct is shaped on the edge foaming produced by means of the method according to the invention.

In an alternative embodiment of the method according to the invention, the duct shaper is a rigid shaping element. For example, the rigid shaping element comprises a plate portion with a bead-like edge region which serves to shape the cable duct.

In order to be able to extract the rigid shaping element from the edge foaming when the surface element is demolded, it can be hinged on the molding tool in the manner of a flap. When the surface element is demolded, the rigid shaping element is then pivoted relative to the molding tool.

In order to extract the duct shaper, the latter can furthermore have a gripping portion. The duct shaper can be pulled out of the edge foaming via the gripping portion, and to be precise manually or also by means of the molding tool. For this purpose, the gripping portion can be connected to a lower die or an upper die of the molding tool.

The subject of the invention is furthermore a device for producing a surface component with a edge foaming on a panel-like surface element. The device comprises a molding tool with a frame-like cavity for shaping the edge foaming, and a duct shaper to be laid inside the cavity and which has a bead-like edge region and a sealing bearing surface for bearing against an inner side of the panel-like surface element. It is possible by means of the duct shaper to shape at the edge foaming a cable duct for an electrical lead which cannot be seen by occupants of the vehicle. In particular, a edge foaming with a trim lip can thus be shaped which extends below the cable duct. The cable duct preferably directly adjoins the panel-like surface element.

The duct shaper can be a flexible plastic profile, in particular a flexible silicone profile, or a rigid plate-like shaping element which is preferably hinged on the molding tool in the manner of a flap.

The duct shaper can furthermore have a gripping portion which can be gripped manually for extraction from the edge foaming or is connected for this purpose to a lower die or an upper die of the molding tool.

The subject of the invention is furthermore a device for producing a surface component with a edge foaming on a panel-like surface element of a vehicle roof, comprising a molding tool with a frame-like cavity for shaping the edge foaming, and at least two sealing inserts to be laid inside the cavity which has in each case a sealing bearing surface for bearing against an inner side of the panel-like surface element, a tubular surface for bearing against an end side of a tube which is an inlaid part of the edge foaming, and at least one material boundary surface which defines a lateral surface of the edge foaming. When the edge foaming is shaped on the surface element, the sealing inserts delimit the end sides of the tube via their tubular surfaces such that a corresponding seal is made and the tube can be foamed into the edge foaming. In the finished component, the edge foaming forms a visible surface of the surface component. The tube itself is expediently not visible from outside and instead is accommodated in the edge foaming.

The tubular surfaces of the sealing inserts are preferably formed in each case on a recess in the side of the relevant sealing insert. The recess can have an in particular keyhole-like basic surface and be provided with a circular retaining portion for the tube. The two sealing inserts thus also form retaining elements for the tube during the foam-molding process such that the position of the tube in the cavity is clearly defined.

In order to be able to position the tube in the cavity simply, the recesses of the sealing inserts preferably in each case have an insertion portion for the tube.

In order to be able to insert the sealing inserts into the molding tool in a defined fashion, they preferably in each case have a positioning device. The positioning device can comprise a magnet and/or a magnetizable material and/or positioning pins.

In a further preferred embodiment of the device according to the invention, the sealing inserts are formed in each case from a solid plastic material, in particular from a solid silicone material. The silicone material has sealing properties.

In an alternative embodiment of the device according to the invention, the sealing inserts are formed in each case from a plastic hollow part, in particular from an injection-molded hollow part.

Further advantages and advantageous embodiments of the subject of the invention can be found in the description, the drawings, and the claims. Within the scope of the invention are all combinations of at least two features disclosed in the description, the claims, and/or the Figures, i.e. each feature mentioned in the description can be part of the claimed subject in its own right irrespective of the further features and/or implementations mentioned in the respective context.

### BRIEF DESCRIPTION OF DRAWINGS

Exemplary embodiments of the invention are illustrated schematically in the drawings in a simplified manner and are explained in detail in the following description. In the drawings:

FIG. 1 shows a perspective plan view of a roof region of a motor vehicle with an adjustable cover element;

FIG. 2 shows a section through the vehicle roof in FIG. 1 along the line II-II in FIG. 1;

FIG. 3 shows a section through an edge region of an alternative embodiment of a surface component of a vehicle roof;

FIG. 4 shows a schematic view from below of the surface component in FIG. 3;

FIG. 5 shows a view from below of an alternative embodiment of a surface component of a vehicle roof;

FIG. 6 shows a device for producing the surface component in FIG. 3;

FIG. 7 shows a tool, which is modified from the embodiment in FIG. 6, for producing a surface component of a vehicle roof;

FIG. 8 shows a section through a further alternative embodiment for producing a surface component of the type illustrated in FIG. 3;

FIG. 9 shows a section through the device in FIG. 8 along the line A-A in FIG. 8;

FIG. 10 shows a section through a further embodiment of a surface component of a vehicle roof;

FIG. 11 shows a view from below of the surface component in FIG. 10;

FIG. 12 shows a perspective view from below of the surface component in FIG. 10;

FIG. 13 shows an enlarged view of a corner region of the surface component in FIG. 10;

FIG. 14 shows a section through a device for producing the surface component in FIGS. 10 to 13 with respect to the line A-A in FIG. 12;

FIG. 15 shows a section through the device with respect to the line B-B in FIG. 12;

FIG. 16 shows a further section through the device with respect to the line D-D in FIG. 13;

FIG. 17 shows a section through the device with respect to the line C-C in FIG. 12;

FIG. 18 shows a perspective view of the sealing element of the device in FIGS. 14 to 17;

FIG. 19 shows a section through the sealing element in FIG. 18 along the line F-F in FIG. 18;

FIG. 20 shows a section, corresponding to FIG. 19, through an alternative embodiment of a sealing element; and

FIG. 21 likewise shows a section, corresponding to FIG. 19, through a further alternative embodiment of a sealing element.

### DETAILED DESCRIPTION

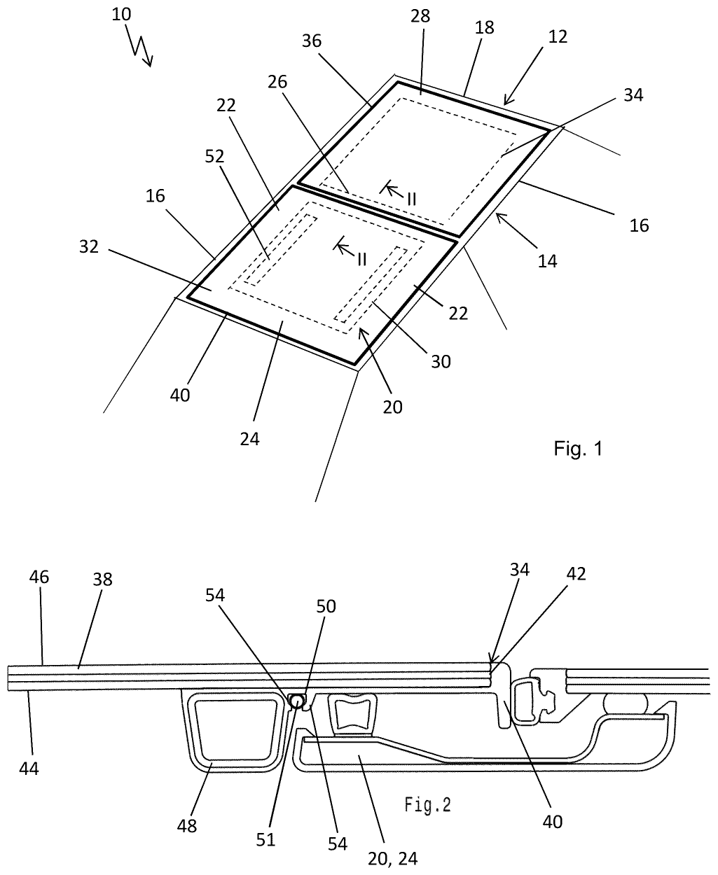

Illustrated in FIGS. 1 and 2 is a roof region of a motor vehicle 10 which is in the form of a car and is equipped with a vehicle roof 12 which is placed on top of a vehicle body shell 14 from above as a preferably modular unit. The vehicle body shell comprises inter alia, on both sides of a vertical roof longitudinal central plane, in each case one roof side rail 16 which extends in the longitudinal direction of the vehicle and laterally delimits the vehicle roof 12. The two roof side rails 16 are connected to each other via roof cross rails 18 which extend in the transverse direction of the vehicle and delimit the vehicle roof 12 at the front and the rear.

The vehicle roof 12 comprises a carrier frame 20 which forms an interface of the vehicle roof 12 with the vehicle body shell 14. The carrier frame 20 is a stamped and bent part, produced preferably as a single piece or from one part, from a sheet-metal plate and comprises two frame side members 22 which extend in the longitudinal direction of the vehicle and the roof, a front frame cross member 24, a central frame cross member 26, and a rear frame cross member 28. The three frame cross members 24, 26, and 28 in each case connect the two frame side members 22 to each other.

The front frame cross member 24, the central frame cross member 26, and the two lateral frame side members 22 delimit a first frame window 30 which is at the front with respect to the driving direction, forms a roof opening, and can be closed by means of an adjustable cover element 32. The cover element 32 is a constituent part of a roof opening system and can be adjusted by means of suitable adjustment kinematics of the roof opening system between a closed position closing the frame window 30 and an open position at least partially uncovering the frame window 30.

The central frame cross member 26 and the rear frame cross member 28 together delimit, with the two frame side members 22, a second frame window 34 which is at the rear with respect to the driving direction and is provided with a window pane element 36 which takes the form of a stationary glass element and is formed in the present case from laminated glass.

The cover element 32, which constitutes a surface component of the vehicle roof 12, comprises as a panel-like surface element a laminated-glass window pane 38 which is provided with a frame-like edge foaming 40 made from a polyurethane foam material. The edge foaming 40 is foamed onto the laminated-glass window pane 38 in such a way that it is applied peripherally against a peripheral edge surface 42 of the laminated-glass window pane 38 and in an edge region likewise peripherally against an inner side 44, facing the interior of the vehicle, of the laminated-glass window pane 38. The edge surface 42 thus extends over the two edges of the laminated-glass window pane 38 extending in the longitudinal direction of the roof and the two edges of the laminated-glass window pane 38 extending in the transverse direction of the roof. An outer side 46 of the laminated-glass window pane 38 facing the surroundings of the vehicle does not have the edge foaming 40.

On the inner side of the laminated-glass window pane 38, the edge foaming 40 accommodates as an inlaid part at least one reinforcement profile 48 which is designed in the present case as a hollow profile. The reinforcement profile 48 illustrated in FIG. 2 extends substantially parallel to a portion of an edge surface 42 extending in the transverse direction of the roof.

A cable duct 50 which is formed as open in the direction of the interior of the vehicle is furthermore shaped on the edge foaming 40, is also shaped in that portion of the edge foaming 40 which is applied against the inner side 44 of the laminated-glass window pane 38, and to be precise in a region between the reinforcement profile 48 and the rear portion of the edge surface 42 extending in the transverse direction of the roof. The cable duct 50 serves to accommodate at least one electrical lead 51 which serves in turn to supply current to an ambient-light lighting device 52, indicated in dashed lines in FIG. 1, of the cover element 32. In order to retain the electrical lead 51 captively in the cable duct 50, the latter is shaped on both sides with undercuts 54 which can be arranged at regular intervals in some places along the extent of the cable duct 50 or can also be formed as continuous.

As illustrated in FIG. 2, the cover element 32 overlaps the frame cross member 24 of the carrier frame 20 with its rear edge region, in which the edge foaming 40 is shaped with the cable duct 50. The cable duct 50 is thus not visible from the interior of the motor vehicle 10. The central frame cross member 24 thus conceals the cable duct 50 and the electrical lead 51 accommodated therein. Further separately applied trims for the cable duct are not necessary.

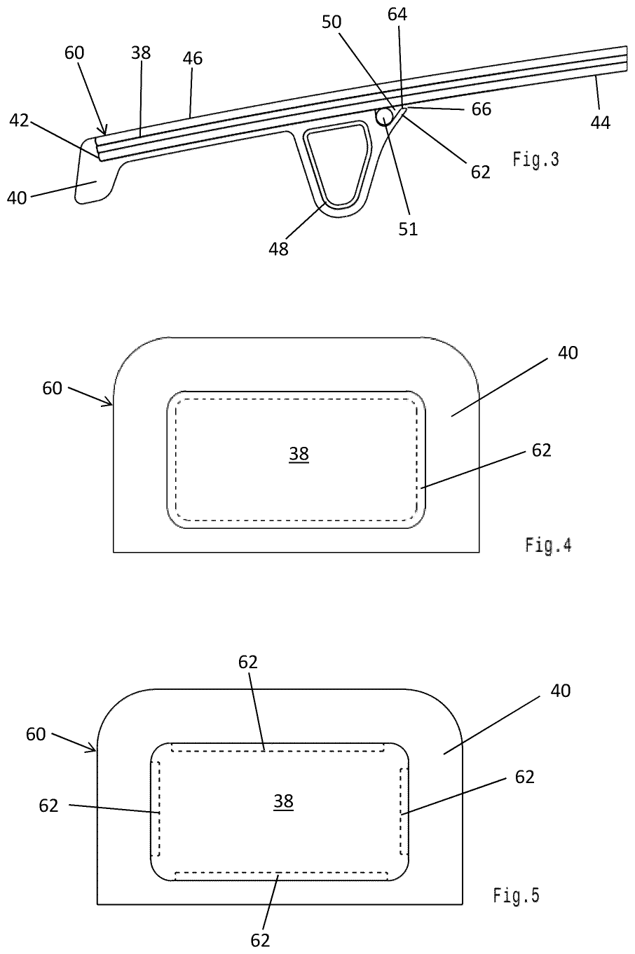

Illustrated in FIGS. 3 and 4 is a cover element 60 which forms an alternative embodiment of a surface component of a vehicle roof according to the invention and is a constituent part of a roof opening system in accordance with the embodiment in FIGS. 1 and 2. The cover element 60 likewise comprises, in accordance with the embodiment in FIGS. 1 and 2, a laminated-glass window pane 38 which is provided with a peripheral edge foaming 40 which is applied in the manner of a frame against a peripheral edge surface 42 and against an inner side 44 of the laminated-glass window pane 38. In addition, the edge foaming 40 accommodates a reinforcement profile 48 in the region arranged on the inner side 44 of the laminated-glass window pane 38.

A peripheral or ring-like cable duct 50, which is delimited above by the inner side 44 of the laminated-glass window pane 38 and below by a trim lip 62 formed by the edge foaming 40, is furthermore shaped by the edge foaming 40 on that side of the reinforcement profile 48 which is remote from the edge surface 42. The trim lip 62 has an edge 64 which is spaced apart from the inner side 44 of the laminated-glass window pane 38 via an edge gap 66. The side of the cable duct 50 is thus open along its extent. At least one electrical lead 51 which serves to supply current to an ambient-light lighting device 52 of the type illustrated in FIG. 1 is accommodated in the cable duct 50. The trim lip 62 is shaped integrally on the edge foaming 40 made from the polyurethane foam material and, as can be seen in FIG. 4, is formed peripherally on the edge foaming 40.

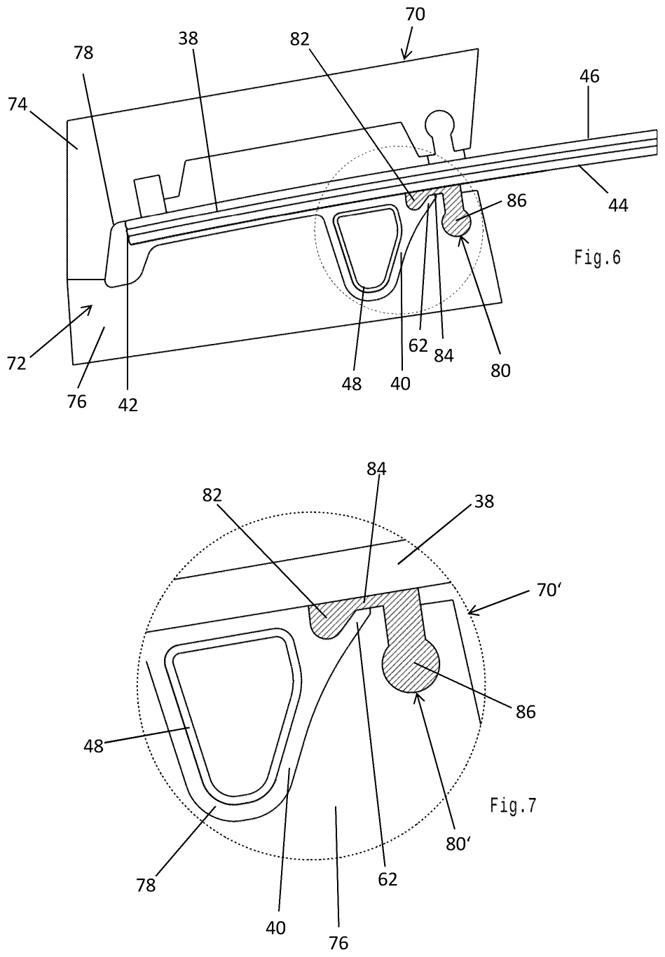

In an alternative embodiment illustrated in FIG. 5 of a cover element 60, a trim lip shaped in accordance with FIG. 3 is not shaped peripherally on the edge foaming 40. Instead, in this embodiment the edge foaming 40 has four trim lips 62, two of which extend on the inner perimeter of the edge foaming 40 in the transverse direction of the roof and two in the longitudinal direction of the roof. Four cable ducts, which are delimited in each case by a trim lip 62 and the cross section of which corresponds to that of the cable duct in FIG. 3, are thus formed on the cover element 60, for which reason reference is made to the relevant description in order to avoid repetition. No trim lips are shaped in the corner regions of the inner edge of the edge foaming 40.

The cover element 60 illustrated in FIGS. 3 and 4 is produced by means of a molding device 70 which is described below on the basis of FIG. 6. The molding device 70 comprises a molding tool 72 which has an upper die 74 and a lower die 76. The upper die 74 and the lower die 76 delimit together a frame-like cavity 78 for molding the edge foaming 40 onto the laminated-glass window pane 38. To do this, the laminated-glass window pane 38 can be laid inside the molding tool 72 in such a way that its edge surface 42 and its edge region arranged on the inner side 44 are arranged in the cavity 78 following the edge region 42 in the manner of a frame.

The molding device 70 furthermore comprises a duct shaper 80 which is likewise formed as peripheral or in the manner of a frame and constitutes a separate component which takes the form of a silicone profile. The duct shaper 80 comprises a bead-like edge region 82 arranged inside the cavity 78, and a plate-like base portion 84 which has, at the top in the installed position illustrated in FIG. 6, a sealing bearing surface which bears against the inner side 44 of the laminated-glass window pane 38. At its edge remote from the bead-like edge region 82, the duct shaper 80 is provided with a gripping portion 86 which, in the embodiment illustrated in FIG. 6, is fixed in a corresponding undercut groove 88 of the lower die 76.

The bead-like edge region 82 of the duct shaper 80 is designed such that it has a flank, facing the gripping portion 86, which is oriented obliquely with respect to the base portion 84 and thus constitutes a demolding slope which facilitates extraction of the duct shaper 80 from the cable duct 50 of the edge foaming 40.

When the cover element 60 is manufactured, the laminated-glass window pane 38 is provided and then, after the reinforcement profile 48 has been positioned, laid inside the molding tool 72 such that, after the molding tool 72 has been closed or after the upper die 74 and lower die 76 have been moved closer together, the edge surface 42 and an underside edge region of the laminated-glass window pane 38 are exposed in the cavity 78. In addition, the duct shaper 80 is positioned in the cavity 78 via the gripping portion 86, which engages in the groove 88 of the lower die 76, in such a way that its base portion bears against the inner side 44 of the laminated-glass window pane 38 with its upper side or bearing surface.

After the molding tool 72 has been closed, a polyurethane foam material is introduced into the cavity 78, as a result of which the edge foaming 40 is shaped on the laminated-glass window pane 38.

Once the polyurethane foam material has hardened sufficiently, the laminated-glass window pane 38 can be demolded, together with the edge foaming 40, after the molding tool 72 has been opened. The duct shaper 80 is deformed here and pulled or extracted via the edge gap 66 from the cable duct 50 created during the molding process. The trim lip is thus bent up elastically. In the demolding process, the duct shaper 80 is retained on the lower die 76 via the gripping portion 86. The edge gap 66 between the edge 64 and the inner side 44 of the laminated-glass window pane 38 is defined by the plate-like base portion 84 of the duct shaper 80 when the edge foaming 40 is shaped.

Illustrated in FIG. 7 is a molding device 70′ which substantially corresponds to the one in FIG. 6 but differs therefrom in the shape of the duct shaper 80′. In particular, the duct shaper 80′ has, in a departure from the embodiment in FIG. 6, a bead-like edge region 82 which has a substantially circular cross section which merges into the substantially plane bearing surface of the base portion 84 on the inner side 44 of the laminated-glass window pane 38, forming a wedge-shaped cavity portion. The molding device 70′ moreover corresponds to the one in FIG. 6, for which reason reference is made to the relevant description in order to avoid repetition.

It is also conceivable that the bead-like edge region 82 of the duct shaper 80′ does not bear against the inner side 44 of the laminated-glass window pane 38 with its whole surface on the laminated-glass window pane 38 side and instead only bears against it in a subregion because of a stepped design. The cable duct is then delimited at least partially also by the plastic of the edge foaming 40 on the glass side or on the laminated-glass window pane 38 side.

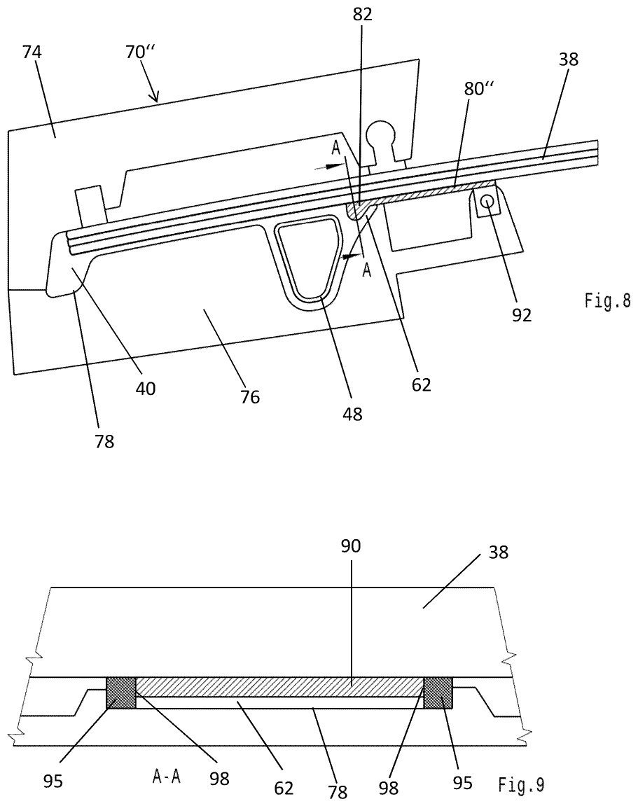

Illustrated in FIGS. 8 and 9 is a molding device 70″ which serves in particular to manufacture the cover element 60 illustrated in FIG. 5. In accordance with the embodiment in FIG. 6, the molding device 70″ has a molding tool 72 which comprises an upper die 74 and a lower die 76 which together delimit a cavity 78 for forming the edge foaming 40. In addition, the molding device 70″ for shaping the four trim lips 62 in each case has a duct shaper 80″ which is formed from a rigid plate-like shaping element 90 which has a bead-like edge region 82 engaging in the cavity 78. When the edge foaming 40 is shaped, the shaping element 90 bears with its upper bearing surface against the inner side 44 of the laminated-glass window pane 38. In its edge region remote from the bead-like edge region 82, the shaping element 90 is applied against a bearing part 94 of the lower die 76 via an axis of rotation 92.

When the device 70 is used or in the method for producing the cover element, the laminated-glass window pane 38 is laid inside the shaping device 70″ in such a way that it rests on the shaping elements 90 in the manner illustrated in FIG. 8. The end sides of the shaping elements 90 which lie inside the cavity 78 are here in each case delimited by a sealing element 95 which is provided with a demolding slope 98 defining the respective end side of the trim lip 62 to be shaped.

After the polyurethane foam material has been introduced into the cavity 78 and after it has hardened sufficiently, the molding device 70″ or its molding tool can be opened and the resulting surface component with the edge foaming 40 demolded. In the demolding process, the shaping elements 90 which constitute flaps are pivoted about the axes of rotation 92 and extracted from the shaped cable ducts 50 via the edge gaps 66. The shaping elements 90 can be provided in each case with a drive means.

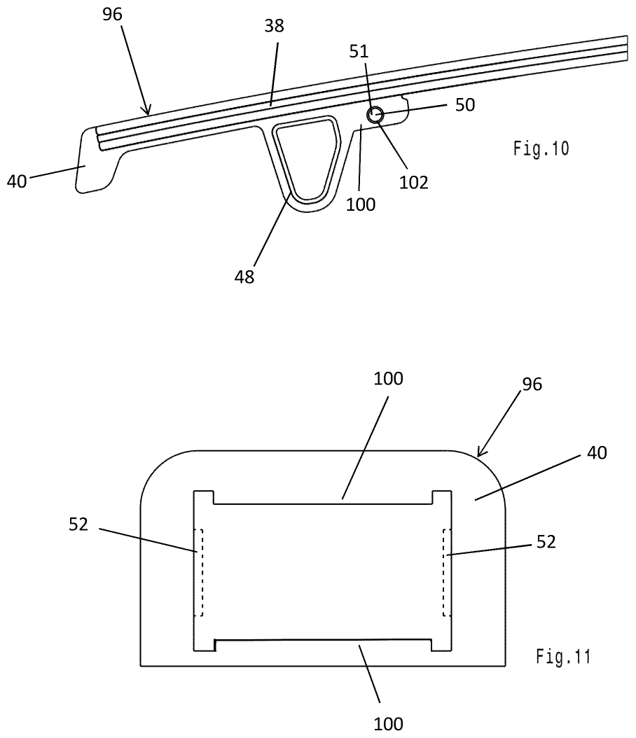

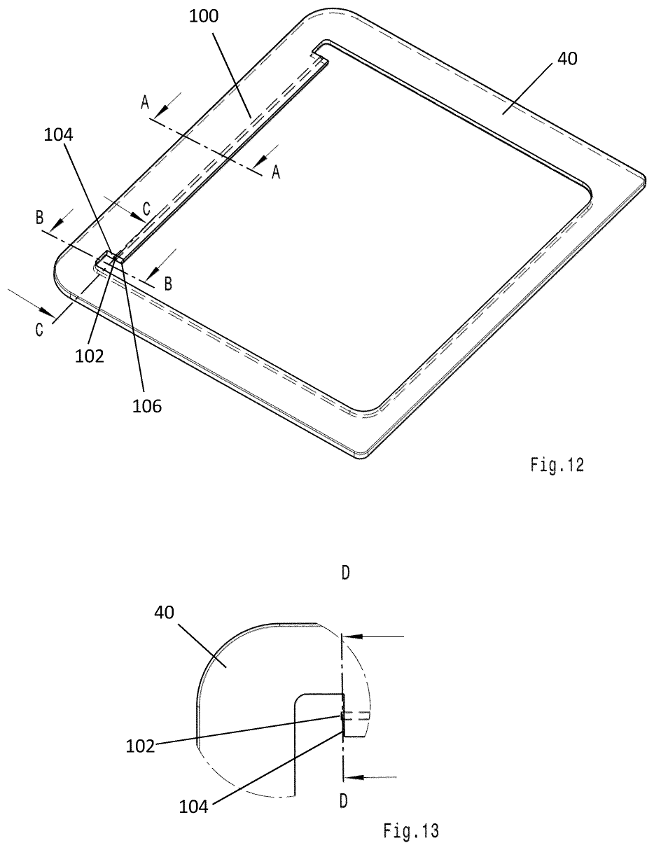

A further embodiment of a cover element 96 of the type illustrated in FIG. 1 is shown in FIGS. 10 to 13. The cover element 96 also comprises a laminated-glass window pane 38 and a edge foaming 40 made from a polyurethane foam material. The edge foaming 40, which is applied peripherally or in the manner of a frame against a peripheral edge surface 42 and peripherally or in the manner of a frame against an edge region on the inside of the laminated-glass window pane 38, has, along the front edge portion and along the rear edge portion, in each case a strip-like projection 100 which projects in the direction of the center of the window pane, extends in the transverse direction of the roof, and accommodates a tube 102 manufactured from plastic as an inlaid part. The tubes 102 form in each case a cable duct for an electrical lead which serves to supply current to an ambient-light lighting device 52 illustrated schematically in FIG. 11. The strip-like projection 100 has end sides 104 at which the tube 102 ends or allows access to the cable duct. As can be seen in FIG. 13, the ends of the tube 102 protrude slightly from the end sides 104. The end sides 104 in each case have a slope 106 between the tube ends and the laminated-glass window pane 38.

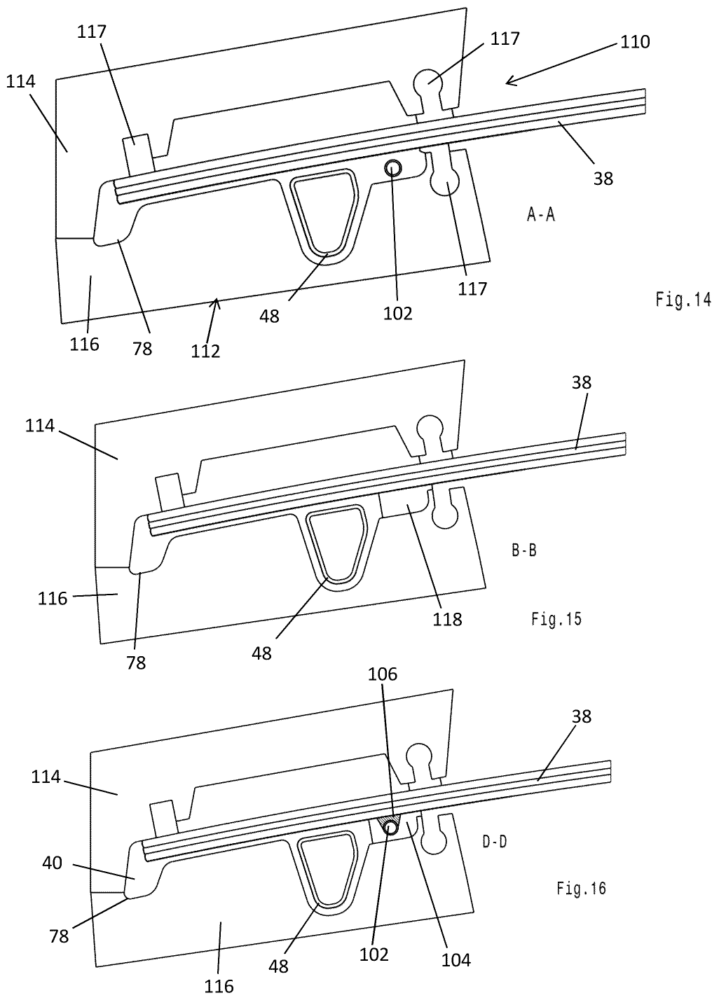

The cover element 96 can be produced by means of the molding device 110 illustrated on the basis of FIGS. 14 to 19. The molding device 110 comprises a molding tool 112 which has an upper die 114 and a lower die 116. When the molding tool 112 is closed, the upper die 114 and the lower die 116 delimit a cavity 78 for shaping the edge foaming 40. The upper die 114 and the lower die 116 are furthermore in each case provided with suitable sealing and bearing elements 118 which seal the frame-like cavity 78 and against which the laminated-glass window pane 38 bears in the closed position of the molding tool 112.

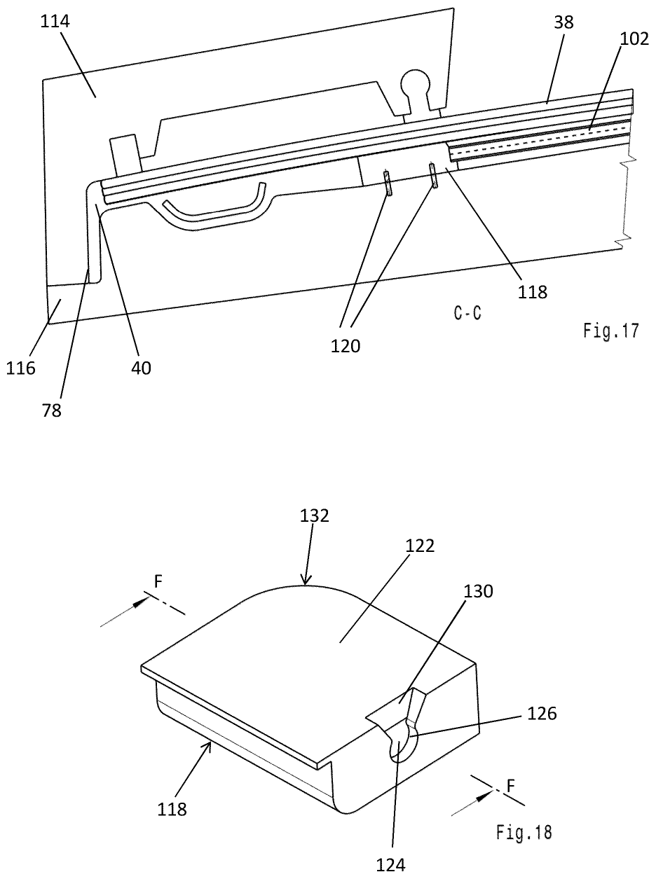

As can be seen in particular in FIGS. 15 and 17, the molding device 110 furthermore has for each strip-like projection 100 two sealing inserts 118 in each case in the form of a silicone block which are in each case retained on the lower die 116 via positioning pins 120, and which, when the molding tool 112 is closed, bear against the inner side 44 of the laminated-glass window pane 38 with its upper side which forms a sealing bearing surface 122. At a lateral surface, the sealing inserts 118 in each case form a tubular surface 124, the base surface of which is defined by a keyhole-shaped lateral recess 126 of the relevant sealing insert 118. The lateral recesses 126 have in each case a largely circular retaining portion 128 and an insertion portion which reaches as far as the bearing surface 122, is wedge-shaped in plan view, and via which the tube 102 is pushed with its end portions into the retaining portions 128 when the tube 102 constituting an inlaid part is arranged in the cavity 78 of the molding tool 112. The base of the insertion portion 130 is positioned at an angle to the base, forming the tubular surface 124, of the retaining portion 128, the respective slope 106 resulting therefrom when the edge foaming 40 is shaped. The sealing inserts 118 furthermore have in each case two side faces 132 which constitute material boundary surfaces which define the inner edge surface of the edge foaming 40 during the foaming process.

When the cover element 96 is produced, the tube 102 is laid inside the cavity 78 of the molding device 110 and retained therein by means of the two sealing inserts 118. In addition, the laminated-glass window pane 38 and reinforcement profiles 48 are laid inside the molding tool 112 as inlaid parts. After the molding tool 112 has been closed, a polyurethane foam material is introduced into the cavity 78. The geometry of the resulting edge foaming 40 is determined by the geometry of the cavity 78 which is delimited on one side by the upper die 114 and the lower die 116 and on the other side by the laminated-glass window pane 38 and by the sealing inserts 118. When the cover element 96 is demolded from the molding tool 112, the sealing inserts 118 are also extracted.

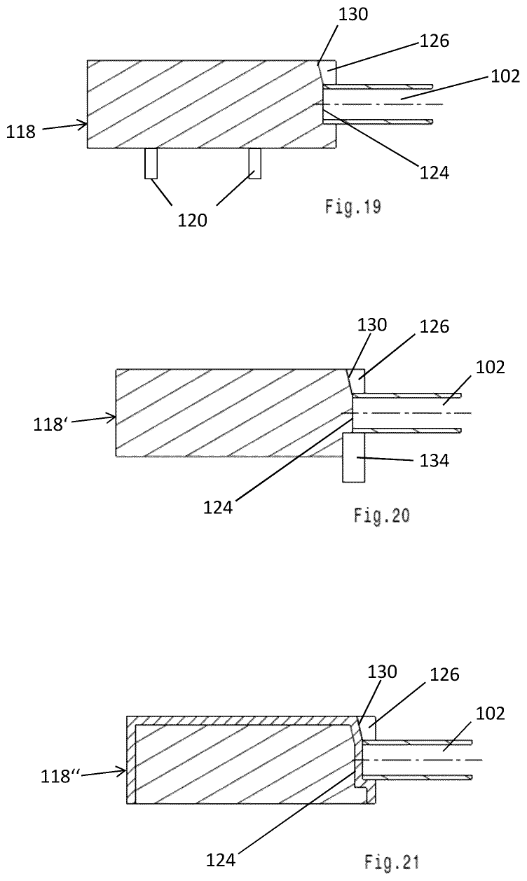

Shown in FIG. 20 is an alternative embodiment of a sealing insert 118′ of the above described type. The sealing insert 118′ differs from the sealing insert illustrated in FIG. 19 in that, instead of the positioning pins 120, it has a magnet 134 which constitutes a positioning means for the sealing insert 118′ such that the latter can be retained in a precise position in the molding tool 112. The sealing insert 118 moreover corresponds to that in FIG. 19.

Shown in FIG. 21 is a further alternative embodiment of a sealing insert 118″ of the type illustrated in FIG. 19. The sealing insert 118″ differs from that in FIG. 19 in that it is formed from a plastic hollow part, in particular from an injection-molded hollow part, the walls of which define the bearing surface 122, the tubular surface 124, and the lateral surfaces 132. The function of the sealing insert 118″ corresponds to that of the sealing insert in FIG. 19, and for this reason reference is made to the relevant description in order to avoid repetition.

### LIST OF REFERENCE SIGNS

10 motor vehicle
12 vehicle roof
14 vehicle body shell
16 roof side rail
18 roof cross rail
20 carrier frame
22 frame side member
24 frame cross member
26 frame cross member
28 frame cross member
30 frame window
32 cover element
34 frame window
36 window pane element
38 laminated-glass window pane
40 edge foaming
42 edge surface
44 inner side
46 outer side
48 reinforcement profile
50 cable duct
51 electrical lead
52 ambient-light lighting device
54 undercut
60 cover element
62 trim lip
64 edge
66 edge gap
70, 70′, 70″ molding device
72 molding tool
74 upper die
76 lower die
78 cavity
80, 80′, 80″ duct shaper
82 edge region
84 base portion
86 gripping portion
88 groove
90 shaping element
92 axis of rotation
94 bearing part
95 sealing element
96 cover element
98 demolding slope
100 projection
102 tube
104 end side
106 slope
110 molding device
112 molding tool
114 upper die
116 lower die
117 sealing and bearing elements
118, 118′, 118″ sealing insert
120 positioning pin
122 bearing surface
124 tubular surface
126 recess
128 retaining portion
130 insertion portion
132 lateral surface
134 magnet

1. A vehicle roof, comprising a surface component which has a panel-like surface element which has an outer side facing the vehicle surroundings and an inner side facing the interior of the vehicle and on which a peripheral edge foaming is formed which is applied against a peripheral edge surface and against the inner side of the surface element in its edge region, wherein, at the edge foaming, a cable duct is shaped which is designed as open on its side along its extent, or wherein foamed into the edge foaming is a tube which forms a cable duct and which extends on the inner side of the surface element at least largely parallel to an edge surface portion of the surface element.

2. The vehicle roof as claimed in claim 1, wherein the edge foaming accommodates a reinforcement profile which substantially follows an edge surface portion of the panel-like surface element, and wherein the cable duct is shaped at the edge foaming on that side of the reinforcement profile which is remote from this edge surface portion.

3. The vehicle roof as claimed in claim 1, wherein the edge foaming has a trim lip which delimits the cable duct and the edge of which is spaced apart from the inner side of the surface element via an edge gap.

4. The vehicle roof as claimed in claim 1, wherein the cable duct is delimited above by the inner side of the surface element.

5. The vehicle roof as claimed in claim 1, wherein the cable duct is formed peripherally.

6. The vehicle roof as claimed in claim 1, wherein the cable duct comprises a substantially straight duct segment which follows an edge surface portion of the panel-like surface element and which is open at its ends.

7. The vehicle roof as claimed in claim 1, wherein the cable duct is open at the side remote from the outer side of the surface element.

8. The vehicle roof as claimed in claim 7, wherein the surface component is an adjustable cover element of a roof opening system which can be adjusted between a closed position closing a roof opening and an uncovered position at least partially uncovering the roof opening, and a carrier frame is provided with a central or rear frame cross member which overlaps the cover element in its closed position with a rear edge region at least partially in such a way that the cable duct is covered by the frame cross member.

9. The vehicle roof as claimed in claim 1, wherein the cable duct is provided with at least one undercut.

10. The vehicle roof as claimed in claim 1, wherein the edge foaming has, along an edge surface portion of the surface element, a strip-like projection in which the cable duct is formed.

11. A method for producing a surface component of a vehicle roof, comprising the following steps:
providing a panel-like surface element which has an inner side and an outer side;
laying the surface element inside a molding tool which comprises a frame-like cavity for forming a edge foaming of the surface element;
positioning a duct shaper in the cavity which has a bead-like edge region, wherein the duct shaper is placed against the inner side of the surface element;
introducing a foam material into the cavity such that the edge foaming is shaped on the surface element; and
demolding the surface element with the edge foaming and extracting the duct shaper from the edge foaming via an edge gap extending along the extent of the edge foaming.

12. The method as claimed in claim 11, wherein the duct shaper is formed from an elastic plastic profile.

13. The method as claimed in claim 11, wherein the duct shaper is a rigid shaping element.

14. The method as claimed in claim 13, wherein the rigid shaping element is hinged on the molding tool in the manner of a flap and, when the surface element is demolded, is pivoted relative to the molding tool in order to extract it from the edge foaming.

15. The method as claimed in claim 11, wherein the duct shaper has a gripping portion and is pulled out of the edge foaming via the gripping portion.

16. A device for producing a surface component with an edge foaming on a panel-like surface element of a vehicle roof, comprising a molding tool with a frame-like cavity for shaping the edge foaming, and a duct shaper to be laid inside the cavity and which has a bead-like edge region and a sealing bearing surface for bearing against an inner side of the panel-like surface element.

17. The device as claimed in claim 16, wherein the duct shaper is a flexible plastic profile.

18. The device as claimed in claim 16, wherein the duct shaper comprises a rigid plate-like shaping element which is preferably hinged on the molding tool in the manner of a flap.

19. The device as claimed in claim 16, wherein the duct shaper has a gripping portion.

20. A device for producing a surface component with an edge foaming on a panel-like surface element of a vehicle roof, comprising a molding tool with a frame-like cavity for shaping the edge foaming, and two sealing inserts to be laid inside the cavity which has in each case a sealing bearing surface for bearing against an inner side of the panel-like surface element, a tubular surface for bearing against an end side of a tube which is an inlaid part of the edge foaming, and at least one material boundary surface which defines a lateral surface of the edge foaming.

21. The device as claimed in claim 20, wherein the tubular surface is formed on a recess in the side of the sealing insert.

22. The device as claimed in claim 21, wherein the lateral recess has a circular retaining portion for the tube.

23. The device as claimed in claim 21, wherein the recess has an insertion portion for the tube.

24. The device as claimed in claim 20, wherein the sealing inserts in each case have a positioning device by means of which the position on the molding tool is defined.

25. The device as claimed in claim 21, wherein the positioning device comprises a magnet and/or a magnetizable material and/or positioning pins.

26. The device as claimed in claim 20, wherein the sealing inserts are formed in each case from a solid plastic material, in particular from a solid silicone material.

27. The device as claimed in claim 20, wherein the sealing inserts are formed in each case from a hollow part.
